(19) United States
(12) Patent Application Publication
(10) Pub. No.: US 2026/0001463 A1
(43) Pub. Date: Jan. 1, 2026

(54) CONTOURED SEAT SUSPENSION

(71) Applicant: GM Global Technology Operations LLC, Detroit, MI (US)

(72) Inventors: Edward Thaddeus Kuczynski, Ann Arbor, MI (US); Daniel Joseph Ridgeway, Grosse Pointe Park, MI (US); Bonita J. Thomas, Linden, MI (US); Jill M. Green, Highland, MI (US); Matthew Cwynar, Pinckney, MI (US); Lindsay J. Nault, Berkley, MI (US); Marielle Lo Day, Milford, MI (US); Matthew Isakson, Royal Oak, MI (US); Victoria F. Streberger, Bruce Twp., MI (US)

(73) Assignee: GM Global Technology Operations LLC, Detroit, MI (US)

(21) Appl. No.: 18/760,677

(22) Filed: Jul. 1, 2024

(51) Int. Cl. B60N 2/70

(52) U.S. Cl. CPC B60N 2/7094

(57) ABSTRACT

A seat assembly includes a frame and a seat bottom connected to the frame. The seat bottom includes a rigid support structure and a suspension extending between the frame and a periphery region of the rigid support structure. Responsive to a user sitting at the seat assembly, the suspension flexes between the rigid support structure and the frame to accommodate movement of the rigid support structure relative to the frame.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a seat assembly for a vehicle, and specifically, to a seat bottom of the seat assembly supported at a seat frame. Traditional seat assemblies include a seat bottom that is rigidly contoured to an average user's body shape, providing a more comfortable seating surface compared to a seat bottom without contouring. For example, a conventional seat bottom may have a slight curvature based on seat and thigh position for an occupant. While the contoured seat bottom offers an ergonomically advantageous surface for many occupants, the seat bottom is generally fixed to the seat frame, such as via welding, threaded fasteners, snap attachment, and the like. Because of this, the seat bottom offers no displacement movement or flexibility, thereby limiting the amount of damping experienced by an occupant when seated on the seat bottom. As a result, forces are directly transferred from the seat to an occupant when the vehicle travels over bumps or uneven roads.

### SUMMARY

One aspect of the disclosure provides a seat assembly. The seat assembly includes a frame and a seat bottom connected to the frame. The seat bottom includes a rigid support structure and a suspension extending between the frame and a periphery region of the rigid support structure. Responsive to a user sitting at the seat assembly, the suspension flexes between the rigid support structure and the frame to accommodate movement of the rigid support structure relative to the frame.

Implementations of the disclosure may include one or more of the following optional features. In some implementations, the rigid support structure includes an ergonomic shape configured to contour to the user sitting at the seat assembly.

In some examples, the suspension includes a plurality of springs. In further examples, springs of the plurality of springs extend between the frame and the rigid support structure along opposing sides of the periphery region of the rigid support structure. In other further examples, springs of the plurality of springs extend between the frame and the rigid support structure along four sides of the periphery region of the rigid support structure.

In some aspects, the suspension includes a flexible fabric. In some implementations, the suspension includes a flexible gasket circumscribing the periphery region of the rigid support structure. In further implementations, the flexible gasket is attached to one selected from the group consisting of (i) an upper surface of the rigid support structure and (ii) a lower surface of the rigid support structure opposite the upper surface.

In some examples, the seat assembly further includes a dampener between a lower surface of the rigid support structure and a lower frame surface located beneath the seat bottom. The dampener includes a first magnet connected to the rigid support structure and a second magnet connected to the lower frame surface. The first magnet and the second magnet repel one another. In some aspects, the suspension accommodates movement of the rigid support structure relative to the frame along three axes.

Another aspect of the disclosure provides a seat assembly. The seat assembly includes a frame and a seat bottom connected to the frame. The seat bottom includes a rigid support structure and a suspension extending between the frame and a periphery region of the rigid support structure. The rigid support structure includes an ergonomic shape configured to contour to a user sitting at the seat assembly. The suspension includes a plurality of springs extending between the frame and the rigid support structure along opposing sides of the periphery region of the rigid support structure. Responsive to a user sitting at the seat assembly, the suspension flexes between the rigid support structure and the frame to accommodate movement of the rigid support structure relative to the frame. This aspect may include one or more of the following optional features.

In some implementations, springs of the plurality of springs extend between the frame and the rigid support structure along four sides of the periphery region of the rigid support structure. In some examples, the suspension accommodates movement of the rigid support structure relative to the frame along three axes.

In some aspects, the seat assembly further includes a dampener between a lower surface of the rigid support structure and a lower frame surface located beneath the seat bottom. In further aspects, the dampener includes a first magnet connected to the rigid support structure and a second magnet connected to the lower frame surface. The first magnet and the second magnet repel one another.

Yet another aspect of the disclosure provides a vehicle. The vehicle includes a seat assembly including a frame and a seat bottom connected to the frame. The seat bottom includes a rigid support structure and a suspension extending between the frame and a periphery region of the rigid support structure. Responsive to a user sitting at the seat assembly, the suspension flexes between the rigid support structure and the frame to accommodate movement of the rigid support structure relative to the frame. This aspect may include one or more of the following optional features.

In some implementations, the rigid support structure includes an ergonomic shape configured to contour to the user sitting at the seat assembly. In some examples, the suspension includes a plurality of springs extending between the frame and the rigid support structure along opposing sides of the periphery region of the rigid support structure.

In some aspects, the suspension includes a flexible gasket circumscribing the periphery region of the rigid support structure. In further aspects, the flexible gasket is attached to one selected from the group consisting of (i) an upper surface of the rigid support structure and (ii) a lower surface of the rigid support structure opposite the upper surface.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle that includes a seat assembly in accordance with the principles of the present disclosure.

FIG. 2 is a perspective view of an interior cabin of the vehicle of FIG. 1 that accommodates the seat assembly of FIG. 1.

FIG. 3 is a perspective view of a frame of the seat assembly of FIG. 1.

FIG. 4 is a perspective view of a seat bottom of the seat assembly of FIG. 1 configured to be supported at the frame via a suspension including a plurality of springs.

FIG. 5 is a perspective view of a seat bottom of the seat assembly of FIG. 1 configured to be supported at the frame via a suspension including a flexible gasket.

FIG. 6 is a perspective view of a seat bottom of the seat assembly of FIG. 1 configured to be supported at the frame via a suspension including a plurality of magnets.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor, other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

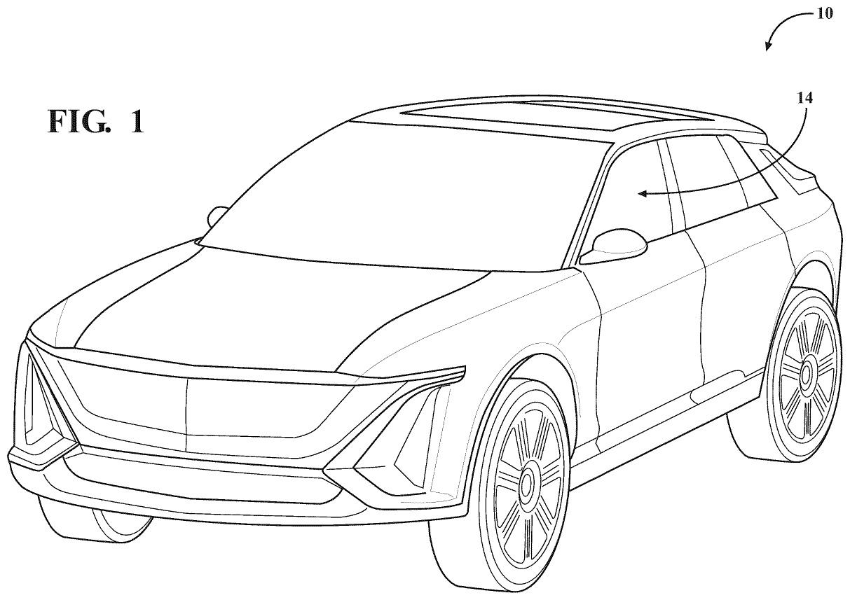

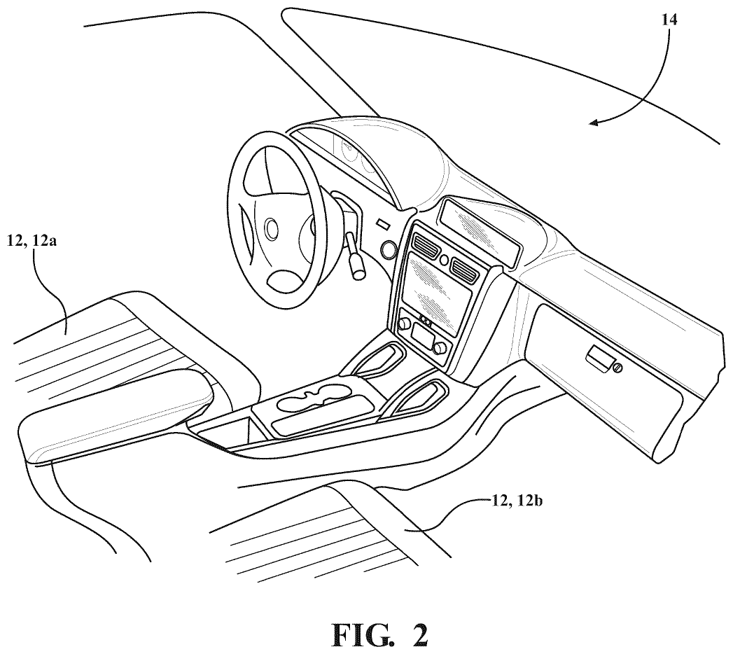

With reference to FIGS. 1 and 2, a vehicle 10 includes an interior cabin 14 accommodating one or more seat assemblies 12 at corresponding seat positions within the interior cabin 14 of the vehicle 10, such as a driver's seat 12, 12a at a driver's seating position and a passenger's seat 12, 12b at a passenger seating position. It can be appreciated that the seat assembly 12 may be located at any passenger position within a vehicle without diverging from the context of this disclosure.

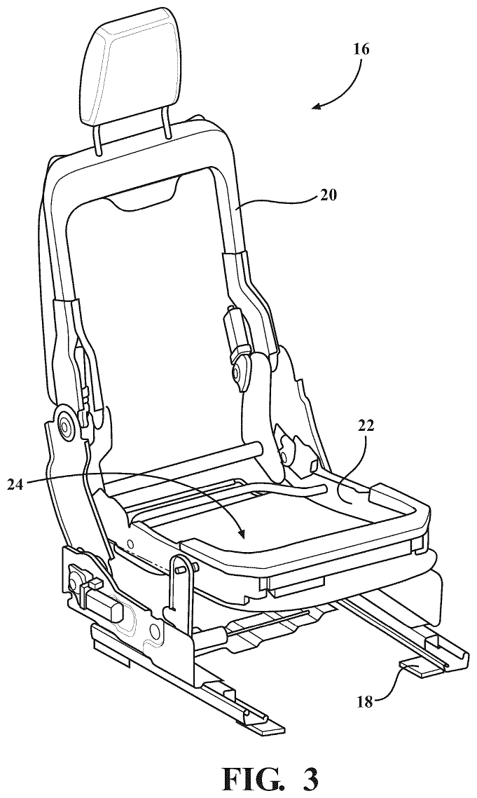

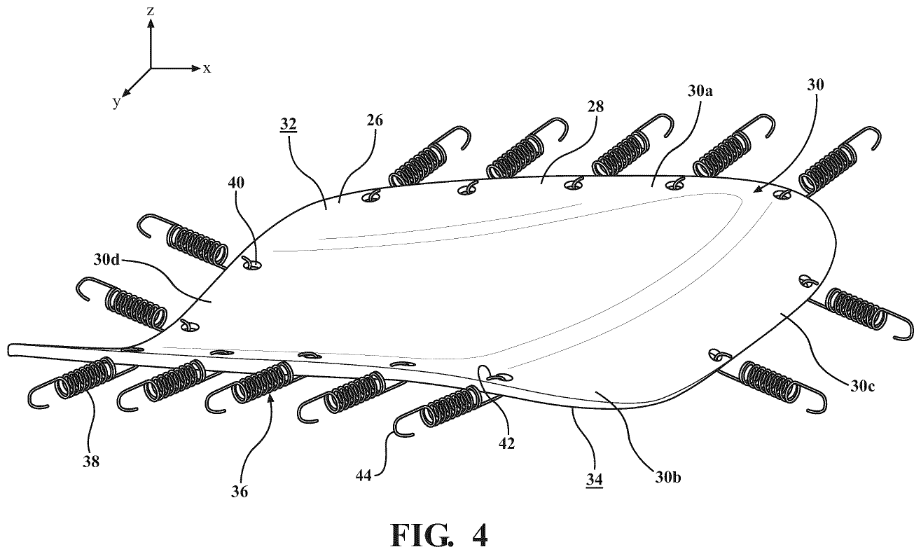

With reference to FIG. 3, the seat assembly 12 includes a support structure or frame 16 configured to support cushioning or padding of the seat assembly 12. The frame 16 and the cushioning may be wrapped in a covering, such as a fabric, vinyl, leather, or other suitable material to provide a Class A surface of the seat assembly 12. Furthermore, the frame 16 may include one or more floor mounts or rails 18 at a lower portion of the frame 16 that are configured to mount the seat assembly 12 within the interior cabin 14 of the vehicle 10, such as to a floor of the interior cabin 14. The frame 16 also includes a back frame portion 20 configured to support the backrest of the seat assembly 12 and a bottom frame portion 22 configured to support the seat cushion of the seat assembly 12. In the illustrated example, the bottom frame portion 22 is positioned generally above the floor mounts 18 of the frame 16 and defines a bottom cavity or seat cushion-receiving portion 24 of the frame 16. That is, the bottom frame portion 22 may generally provide a peripheral frame structure with the bottom cavity 24 extending between or within the bottom frame portion 22. Thus, the bottom cavity 24 is circumscribed by the bottom frame portion 22 and is configured to receive a seat bottom or cushion assembly 26 of the seat assembly 12 (FIG. 4). As discussed further below, the seat bottom 26 may include cushioning and the seat bottom 26 and bottom frame portion 22 may be wrapped in the covering of the seat assembly 12.

With reference to FIG. 4, the seat bottom 26 includes a rigid support structure 28 that is connected or supported at the bottom frame portion 22 of the frame 16. Although not shown, the rigid support structure 28 of the seat bottom 26 may support and/or be wrapped in cushioning or padding material. The rigid support structure 28 may be formed from any suitable material that provides rigid support to the user when sitting in the seat assembly 12, such as wood, composite, metal, or the like. Furthermore, the rigid support structure 28 includes an ergonomic shape or contour, such as a shape based on an average user of the seat assembly 12. By incorporating a contoured shape into the rigid support structure 28, even if the rigid support structure 28 is eventually covered by foam, leather, fabric, and/or other materials, the contoured shape helps the user experience a more comfortable and form-fitting seating experience, especially if the user is sitting at the seat assembly 12 for an extended period of time. As discussed further below, the rigid support structure 28 is supported at the bottom frame portion 22 of the frame 16 via a flexible suspension 36 extending between a perimeter or peripheral edge region 30 of the support structure 28 and the bottom frame portion 22.

The seat bottom 26 includes a first or upper surface 32 and a second or lower surface 34 opposite the upper surface 32. The upper surface 32 may face the interior cabin 14 of the vehicle 10 and includes the contoured shape of the rigid support structure 28 so that the upper surface 32 is configured to receive the user sitting at the seat assembly 12. The lower surface 34 may face away from the interior cabin 14 such as toward the floor of the interior cabin 14.

The suspension 36 extends between the peripheral edge region 30 of the support structure 28 and the bottom frame portion 22 and flexes between the support structure 28 and the bottom frame portion 22 to accommodate movement of the seat bottom 26 and user relative to the frame 16. For example, as the vehicle travels along the road, the suspension 36 may flex or deflect to accommodate movement of the support structure 28 relative to the frame 16 and to at least partially attenuate or absorb forces, thereby restricting the forces from travelling through the seat assembly 12 to the user.

That is, by attaching the seat bottom 26 to the frame 16 with the suspension 36, the seat bottom 26 is able to offer occupant deflection to the user while sitting at the seat assembly 12. Occupant deflection provides an additional degree of suspension to the user that provides enhanced comfort, especially when the vehicle 10 is traveling over bumpy and/or uneven roads. For example, the suspension 36 may allow the seat bottom 26 to move along three axes of movement relative to the frame 16. In other words, and as shown in FIG. 4, the suspension 36 enables the seat bottom 26 to move in an X direction (e.g., along a longitudinal axis of the vehicle), a Y direction (e.g., along a lateral axis of the vehicle), and a Z direction (along a vertical axis). When the suspension 36 is combined with the contoured shape of the rigid support structure 28, the user is provided with a seat bottom 26 that not only contours to the shape of the user, but also, provides enhanced suspension to increase the level of comfort to the user, especially when the vehicle 10 is in motion. Furthermore, the suspension 36 may flex responsive to the user sitting at the seat assembly 12, offering a more comfortable feel at the seat bottom 26 even when the vehicle 10 is not in motion.

In some examples, the suspension 36 includes a plurality of springs 38 extending between at least a portion of the peripheral edge region 30 of the rigid support structure 28 and the bottom frame portion 22. For example, the springs 38 may extend between the rigid support structure 28 and the bottom frame portion 22 along opposing sides of the rigid support structure 28, such as along a first side 30a of the peripheral edge region 30 and along an opposing second side 30b of the peripheral edge region 30. Optionally, the springs 38 may extend between the rigid support structure 28 and the bottom frame portion 22 substantially about the peripheral edge region 30, such as along the first side 30a, the second side 30b, a third or front side 30c, and a fourth or rear side 30d.

A plurality of mounting holes 40 may be formed about the peripheral edge region 30 of the support structure 28 to accommodate attachment of the plurality of springs 38. In one configuration, the springs 38 are coil springs movable between a relaxed state and an expanded or extended state. Thus, each spring 38 includes a first end 42 attached at the peripheral edge region 30 of the rigid support structure 28, such as within a corresponding mounting hole 40, and a second end 44 attached to the bottom frame portion 22 in a corresponding mounting hole (none shown). Thus, the seat bottom 26 may not directly contact any portion of the frame 16 but, rather, the seat bottom 26 is connected to the frame 16 via the plurality of springs 38. Because of this, the seat bottom 26 is provided with three-dimensional movement relative to the frame 16. That is, as the support structure 28 and attached cushioning move relative to the bottom frame portion 22 with the user, the springs 38 expand and contract to support the user and absorb forces, thereby restricting the forces from transferring from the seat assembly 12 to the user. Further, the suspension 36 may urge the support structure 28 toward a centered or default position, such as to retain the user in a desired seating position when travelling along uneven or bumpy roads.

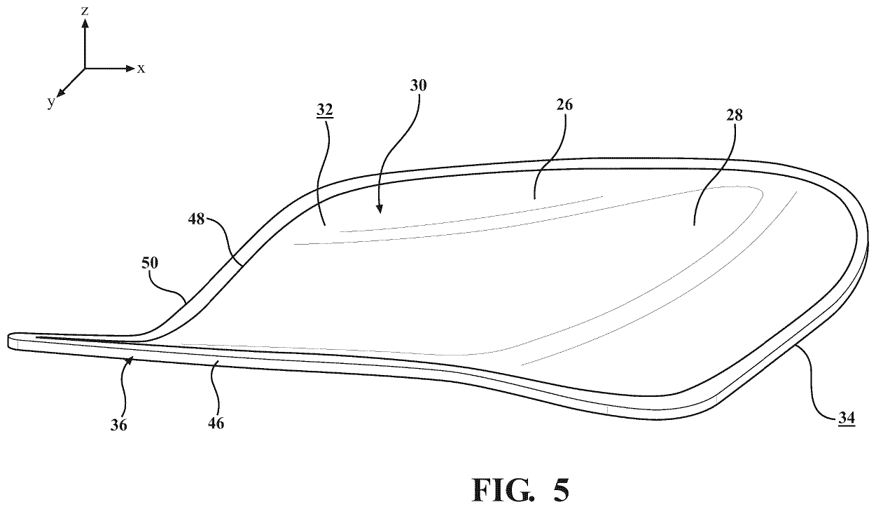

Optionally, the suspension 36 may include a flexible fabric extending between the support structure 28 and the bottom frame portion 22. For example, and with reference to FIG. 5, the suspension 36 may include a flexible fabric 46 that is attached at the peripheral edge region 30 of the rigid support structure 28 and circumscribing the seat bottom 26. The flexible fabric 46 includes a seat edge 48 that attaches to the seat bottom 26 and a frame edge 50 that attaches to the bottom frame portion 22. The flexible fabric 46 may be attached to the seat bottom 26 and the bottom frame portion 22 via any suitable means, such as an adhesive, screws, and the like. Furthermore, the type of flexible fabric 46 that is used for the suspension 36 may include a woven fabric, a metallic mesh, a rubber sheet, or any suitable material for supporting the user sitting at the seat assembly 12 and enabling three-dimensional movement of the seat bottom 26 relative to the frame 16. Thus, as the support structure 28 and attached cushioning move relative to the bottom frame portion 22 with the user, the flexible fabric 46 may flex and/or stretch to support the user and absorb forces. In so doing, the forces experienced by the bottom frame portion 22 caused the vehicle 10 traveling over rough or uneven road surfaces will be absorbed by the suspension 36 and will not be transmitted to the user.

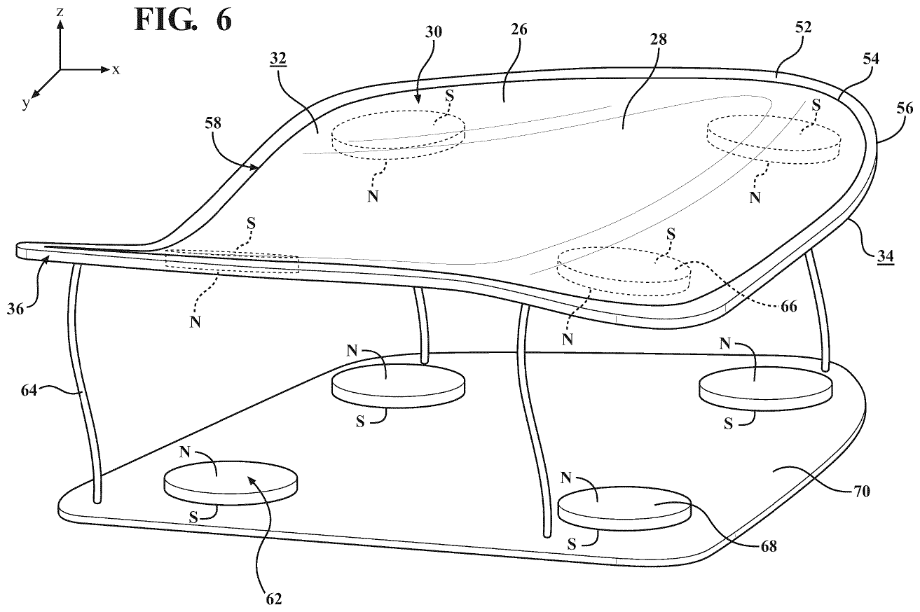

Optionally, the suspension 36 may include a flexible gasket or rubberized material circumscribing the peripheral edge region 30 of the rigid support structure 28. For example, and with reference to FIG. 6, the suspension 36 may include a flexible gasket 52 that is attached at the peripheral edge region 30 of the rigid support structure 28 and circumscribing the seat bottom 26. The flexible gasket 52 includes a gasket seat edge 54 that attaches to the seat bottom 26 and a gasket frame edge 56 that attaches to the bottom frame portion 22. The gasket seat edge 54 may be attached to at least one of an upper edge portion of a perimeter edge 58 of the support structure 28 (i.e., at a joint between the perimeter edge 58 and the upper surface 32 of the support structure 28) and a lower edge portion of the perimeter edge 58 (i.e., at a joint between the perimeter edge 58 and the lower surface 34 of the support structure 28). The flexible gasket 52 may be attached to the seat bottom 26 and the bottom frame portion 22 via any suitable means, such as an adhesive, screws, and the like. Furthermore, the type of flexible gasket 52 that is used for the suspension 36 may include a rubber or silicone gasket, a foam material, or other suitably flexible and durable material for supporting the user sitting at the seat assembly 12, and enabling three-dimensional movement of the seat bottom 26 relative to the frame 16. Thus, as the support structure and attached cushioning move relative to the bottom frame portion 22 with the user, the flexible gasket 52 may flex and/or stretch to support the user and absorb forces. In so doing, the forces experienced by the bottom frame portion 22 caused by the vehicle 10 traveling over rough or uneven road surfaces will be absorbed by the suspension 36 and will not be transmitted to the user.

With continued reference to FIG. 6, the seat assembly 12 includes one or more dampeners 62 that provide a damping action to resist movement of the seat bottom 26 with the user sitting at the seat assembly 12. Although shown in FIG. 6 as including the flexible gasket 52 of the suspension 36 and the one or more dampeners 62, it should be understood that the seat assembly 12 may include one or more of the suspension components discussed herein and/or one or more dampeners 62. That is, the dampeners 62 may be equipped at the seat assembly 12 in conjunction with the suspension 36 including one or more of the plurality of springs 38, the flexible fabric 46, and the flexible gasket 52. As discussed further below, the one or more dampeners 62 are disposed between the rigid support structure 28 and a surface or structure beneath the seat bottom 26 to resist movement of the seat bottom 26 at least in the vertical Z direction. The dampeners 62 may provide less rigid support than the frame 16 of the seat assembly 12 to at least partially attenuate or absorb forces, thereby restricting forces from being realized by the user. One or more tie downs or straps 64 may extend between the seat bottom 26 and the frame 16 to constrain movement of the seat bottom 26 within a range of motion. That is, the tie downs 64 may prevent fugitive movement of the seat bottom 26 and maintain consistent three-dimensional movement.

In the illustrated example, each dampener 62 includes a first magnet 66 disposed at the lower surface 34 of the rigid support structure 28 and a corresponding second magnet 68 at a lower frame surface 70 that is beneath the seat bottom 26, such as at or near the floor mounts 18 of the frame 16. The first magnet 66 and the second magnet 68 repel one another to provide the damping force between the lower frame surface 70 and the support structure 28. For example, the first magnet 66 may have a North pole facing a North pole of the second magnet 68. The tie downs 64 may keep the first magnets 66 positioned generally above the second magnets 68 to maintain the repelling action of the first magnet 66 and the second magnet 68 against one another. While the suspension 36 accommodates three-dimensional movement of the seat bottom 26, the dampener 62 may at least partially preclude movement along the vertical Z direction and may reduce vibrations from transferring to the user through the seat assembly 12. In some examples, the magnets of the dampeners 62 may be electromagnets so that the dampeners may be selectively activated, such as based on a user input or based on a determination that the vehicle is travelling over a particularly bumpy stretch of road.

By connecting the seat bottom 26 to the frame 16 via the suspension 36, combined with the rigid support structure 28 of the seat bottom 26 offering a shape that is specifically contoured to the user, the seat assembly 12 offers ergonomic comfort and support to the user. The configurations as described in this disclosure may be individually tailored to different seat assemblies in different vehicles, as well as fitted to different passenger positions within different vehicles, based on manufacturer preference. The differences in configurations may include, but are not limited to, the exact placement and orientation of the suspension, the stiffness of the suspension, whether dampeners are incorporated, and the exact shape of the contoured seat bottom.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A seat assembly comprising:
a frame;
a seat bottom connected to the frame, the seat bottom comprising a rigid support structure and a suspension extending between the frame and a periphery region of the rigid support structure; and
wherein, responsive to a user sitting at the seat assembly, the suspension flexes between the rigid support structure and the frame to accommodate movement of the rigid support structure relative to the frame.

2. The seat assembly of claim 1, wherein the rigid support structure comprises an ergonomic shape configured to contour to the user sitting at the seat assembly.

3. The seat assembly of claim 1, wherein the suspension comprises a plurality of springs.

4. The seat assembly of claim 3, wherein springs of the plurality of springs extend between the frame and the rigid support structure along opposing sides of the periphery region of the rigid support structure.

5. The seat assembly of claim 3, wherein springs of the plurality of springs extend between the frame and the rigid support structure along four sides of the periphery region of the rigid support structure.

6. The seat assembly of claim 1, wherein the suspension comprises a flexible fabric.

7. The seat assembly of claim 1, wherein the suspension comprises a flexible gasket circumscribing the periphery region of the rigid support structure.

8. The seat assembly of claim 7, wherein the flexible gasket is attached to one selected from the group consisting of (i) an upper surface of the rigid support structure and (ii) a lower surface of the rigid support structure opposite the upper surface.

9. The seat assembly of claim 1, further comprising a dampener between a lower surface of the rigid support structure and a lower frame surface disposed beneath the seat bottom, the dampener comprising a first magnet connected to the rigid support structure and a second magnet connected to the lower frame surface, the first magnet and the second magnet repelling one another.

10. The seat assembly of claim 1, wherein the suspension accommodates movement of the rigid support structure relative to the frame along three axes.

11. A seat assembly for a vehicle, the seat assembly comprising:
a frame;
a seat bottom connected to the frame, the seat bottom comprising a rigid support structure and a suspension extending between the frame and a periphery region of the rigid support structure, the rigid support structure comprising an ergonomic shape configured to contour to a user sitting at the seat assembly, and the suspension comprising a plurality of springs extending between the frame and the rigid support structure along opposing sides of the periphery region of the rigid support structure; and
wherein, responsive to a user sitting at the seat assembly, the suspension flexes between the rigid support structure and the frame to accommodate movement of the rigid support structure relative to the frame.

12. The seat assembly of claim 11, wherein the plurality of springs extend between the frame and the rigid support structure along four sides of the periphery region of the rigid support structure.

13. The seat assembly of claim 11, wherein the suspension accommodates movement of the rigid support structure relative to the frame along three axes.

14. The seat assembly of claim 11, further comprising a dampener between a lower surface of the rigid support structure and a lower frame surface located beneath the seat bottom.

15. The seat assembly of claim 14, wherein the dampener comprises a first magnet connected to the rigid support structure and a second magnet connected to the lower frame surface, the first magnet and the second magnet repelling one another.

16. A vehicle comprising:
a seat assembly comprising:
a frame;
a seat bottom connected to the frame, the seat bottom comprising a rigid support structure and a suspension extending between the frame and a periphery region of the rigid support structure; and
wherein, responsive to a user sitting at the seat assembly, the suspension flexes between the rigid support structure and the frame to accommodate movement of the rigid support structure relative to the frame.

17. The vehicle of claim 16, wherein the rigid support structure comprises an ergonomic shape configured to contour to the user sitting at the seat assembly.

18. The vehicle of claim 16, wherein the suspension comprises a plurality of springs extending between the frame and the rigid support structure along opposing sides of the periphery region of the rigid support structure.

19. The vehicle of claim 16, wherein the suspension comprises a flexible gasket circumscribing the periphery region of the rigid support structure.

20. The vehicle of claim 19, wherein the flexible gasket is attached to one selected from the group consisting of (i) an upper surface of the rigid support structure and (ii) a lower surface of the rigid support structure opposite the upper surface.
